(19) United States
(12) Patent Application Publication
(10) Pub. No.: US 2007/0296713 A1
(43) Pub. Date: Dec. 27, 2007

(54) METHOD AND APPARATUS FOR DRIVING A PLURALITY OF DISPLAY DEVICES USING A SINGLE VIDEO STREAM

(75) Inventors: Jung-woo KIM, Yongin-si (KR); Sung-kee KANG, Seongnam-si (KR); Hong-shik SHIM, Seoul (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD.,, Suwon-si (KR)

(21) Appl. No.: 11/610,014

(22) Filed: Dec. 13, 2006

(30) Foreign Application Priority Data
Jun. 9, 2006 (KR) 1020060052099

(51) Int. Cl. G09G 5/00

(52) U.S. Cl. 345/204

(57) ABSTRACT

A method for driving a plurality of display devices includes Arranging image data to be output to the display devices in an alternating sequence and used to construct a single video stream. The constructed video stream is transmitted to each of the display devices using a single video driver. The image data corresponding to each display device is extracted from the transmitted video stream through a corresponding one of a plurality of decoders connected to a display device and the extracted image data is displayed in the display device.

This application claims priority to Korean Patent application No. 10-2006-0052099, filed on Jun. 9, 2006, and all the benefits accruing therefrom under 35 U.S.C. § 119, the contents of which in its entirety are herein incorporated by reference.

### BACKGROUND OF THE INVENTION

1. Field of the Invention

The present invention relates to a method and apparatus for driving a plurality of display devices. More particularly, the present invention relates to a method and apparatus for driving display devices using a single video stream.

2. Description of the Related Art

Growth of the media industry has lead to research and development on display devices. Particularly, research and development on display devices are conducted to increase the sizes of display devices, improve the image quality thereof, and manufacture compact and lightweight display devices.

To drive a display device, a video driver that provides images to be displayed on the display device is required. A video driver is connected to a display device to provide images to the display device using a separate connecting line for each connected display device. When a plurality of display devices is connected, a relatively large number of interconnection lines are used to connect the display devices to the video driver. As a result, configuring a system including a plurality of display devices becomes difficult.

FIG. 1 is an exemplary block diagram of a system for providing images to a plurality of display devices according to the prior art.

Referring to FIG. 1, when images are provided to the display devices using a video driver, a separate connecting line is used for each display device so that the video driver may provide the images to each display device. To configure a system for driving a plurality of display devices, interconnection lines are required of a number equal to the number of display devices, making it relatively difficult to configure the system. Since many pins are required in the display devices for connection with the interconnection lines of the video driver, there is a limitation in manufacturing compact and lightweight display devices. Therefore, a method and apparatus for driving a plurality of display devices with a single video stream is necessary.

### BRIEF SUMMARY OF THE INVENTION

An exemplary embodiment provides a method and system for driving a plurality of display devices, in which the number of interconnection lines required for providing image data and the number of pins required for interconnection are minimized when image data to be displayed is provided to the plurality of display devices using a single video driver.

An exemplary embodiment provides a computer-readable recording medium having recorded thereon a program for implementing the method.

In an exemplary embodiment, there is provided a method for driving a plurality of display devices using a single video stream. The method includes constructing the single video stream by arranging units of image data to be displayed in each of the display devices in an alternating sequence, transmitting the constructed video stream to the display devices using a single video driver, extracting the image data for a display device using a decoder connected to the display device according to the sequence of the arranged image data in the video stream and displaying the extracted image data.

In an exemplary embodiment, there is provided a computer-readable recording medium having recorded thereon a program for implementing the method for driving a plurality of display devices using a single video stream on a computer.

In an exemplary embodiment, there is provided a system for driving a plurality of display devices using a single video stream. The system includes an image data construction unit that constructs the single video stream by arranging units of image data to be displayed in each of the display devices in an alternating sequence, a video driver that transmits the constructed video stream to the display devices, and a plurality of decoders. Each of the decoders is connected to one of the display devices and extracts the image data for a display device according to the sequence the image data is arranged in the video stream.

### BRIEF DESCRIPTION OF THE DRAWINGS

The above and other aspects, features and advantages of the present invention will become readily apparent by reference to the following detailed description when considered in conjunction with the accompanying drawings wherein:

FIG. 1 is a block diagram of a conventional system for providing an image to a plurality of display devices according to the prior art;

FIG. 2 is a block diagram of an exemplary embodiment of a system for driving a plurality of display devices using a single video stream according to the present invention;

FIG. 3A is a diagram illustrating an exemplary embodiment of a pixel structure of two display devices used to display image data, which form video streams transmitted to the display devices according to the present invention;

FIG. 3B is a diagram illustrating an exemplary embodiment of a video stream formed by the display devices illustrated in FIG. 3A according to the present invention;

FIG. 4 is a timing diagram of an exemplary embodiment of a clock cycle of each decoder connected to one of the display devices according to the present invention; and

FIG. 5 is a flowchart illustrating an exemplary embodiment of a method for driving a plurality of display devices according to the present invention.

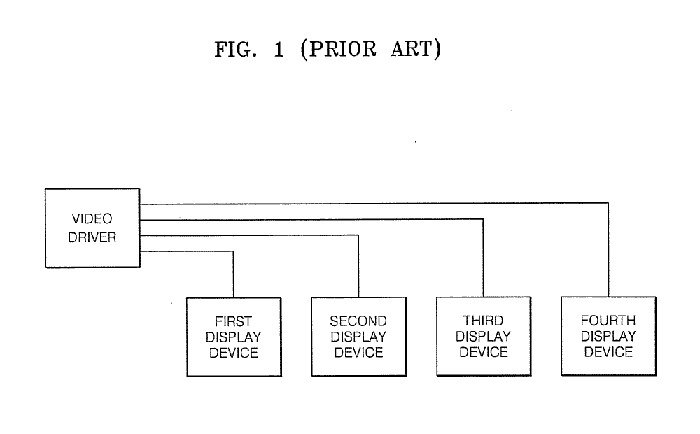

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element or layer is referred to as being “connected to” another element, the element can be directly connected to another element or intervening elements. In contrast, when an element is referred to as being “directly connected to” another element, there are no intervening elements present. Like numbers refer to like elements throughout. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first thin film could be termed a second thin film, and, similarly, a second thin film could be termed a first thin film without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, an exemplary embodiment of the present invention will be described in detail with reference to the accompanying drawings.

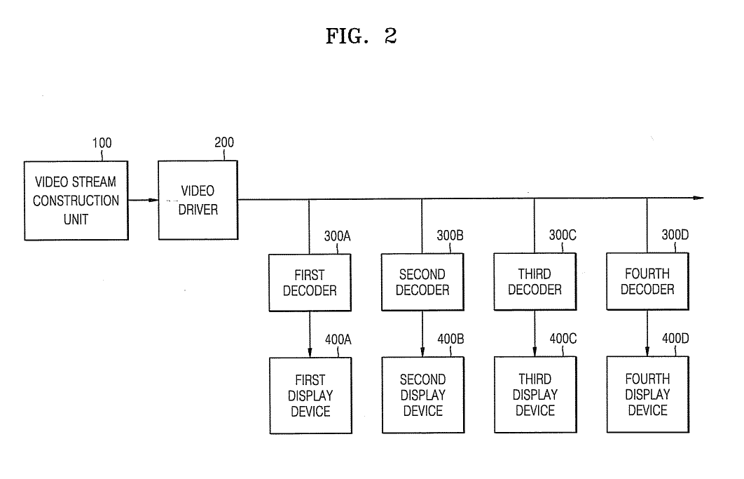

FIG. 2 is a block diagram of an exemplary embodiment of a system for driving a plurality of display devices using a single video stream according to the present invention.

The system includes a video stream construction unit 100, a video driver 200, a plurality of display devices and a plurality of decoders. The plurality of display devices includes a first display device 400a, a second display device 400b, a third display device 400c, and a fourth display device 400d. The plurality of decoders includes a first decoder 300a, a second decoder 300b, a third decoder 300c, and a fourth decoder 300d, which are respectively connected to the first display device 400a, the second display device 400b, the third display device 400c, and the fourth display device 400d. Although four display devices are used in the illustrated embodiment, such number is used only for exemplary purposes and does not limit the scope the present invention.

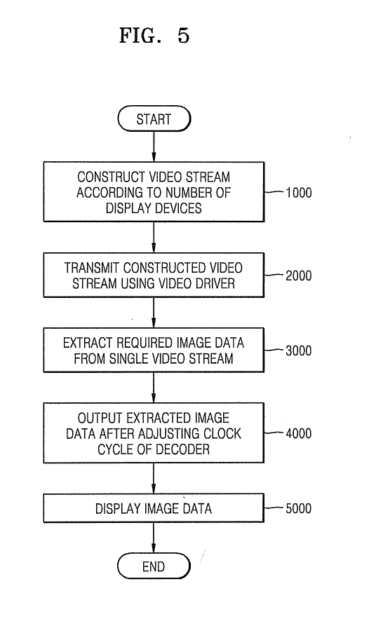

FIG. 5 is a flowchart illustrating an exemplary embodiment of a method for driving a plurality of display devices according to the present invention.

Referring to FIG. 5, an image data construction unit constructs a video stream according to the number of display devices in operation 1000 so that a video driver may drive image data displayed in the display devices. In the system of FIG. 2, the video stream construction unit 100 constructs the video stream according to the number of display devices 400a, 400b, 400c, and 400d in operation 1000 so that the video driver 200 may drive the image data displayed in the first through fourth display devices 400a, 400b, 400c, and 400d.

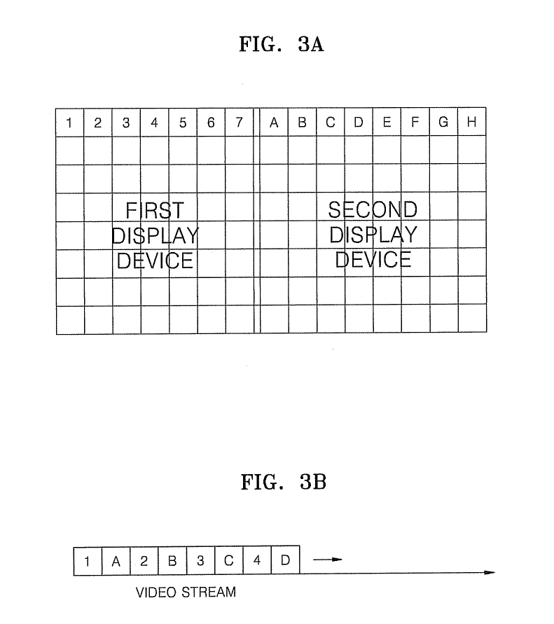

FIG. 3A is a diagram illustrating an exemplary embodiment of a pixel structure of two display devices used to display image data, which form video streams transmitted to the display devices according to the present invention.

Although four display devices are connected to a single video driver in the exemplary embodiment of a system illustrated in FIG. 2, pixels of two display devices, which are used for construction of video streams transmitted to the two display devices, are illustrated in FIG. 3A. The two display devices are shown for exemplary purposes and do not limit the scope the present invention.

Since a system for driving a plurality of display devices may be configured regardless of the number of display devices, a video stream may be formed in the manner provided in FIG. 3A with any of a number of display devices, such as four display devices as illustrated in FIG. 2.

Referring to FIG. 3A, image data to be displayed in two display devices is expressed in units of pixels in the display devices. In the illustrated embodiment, only the pixels units of the first rows of the displayed screen are shown. In the first display device, e.g., 400a, pixels corresponding to the first row of a displayed screen are arranged in the order of 1, 2, 3, 4, 5, 6, and 7 from left to right. In the second display device, e.g., 400b, pixels corresponding to the first row of a displayed screen are arranged in the order of A, B, C, D, E, F, G, and H from left to right. The reference numbers “1, 2, 3, 4, 5, 6, 7” and reference characters “A, B, C, D, E, F, G, H” are exemplary embodiments set to identify each pixel and do not limit the scope of the present invention.

The video stream construction unit 100 in FIG. 2 forms a video stream by arranging image data in operation 1000 (FIG. 5). Referring to FIGS. 3A and 3B, the video stream construction unit 100 extracts pixel data “1” arranged leftmost in the first row of the screen of the first display device 400a and arranges the extracted pixel data “1” as the first component of the video stream. The video stream construction unit 100 extracts pixel data “A” arranged leftmost in the first row of the screen of the second display device 400b and arranges the extracted pixel data “A” as the second component of the video stream. The video stream construction unit 100 extracts pixel data “2” arranged in the second column from the left in the first row of the screen of the first display device 400a and arranges the extracted pixel data “2” as the third component of the video stream. The video stream construction unit 100 extracts pixel data “B” arranged in a second column from the left in the first row of the screen of the second display device 400b and arranges the extracted pixel data “B” as the fourth component of the video stream. In this way, the video stream construction unit 100 forms the video stream by alternately extracting pixel data of the first rows of the screens of the display devices 400a and 400b in a left-to-right direction and arranging the extracted pixel data in order of the extraction.

Although only two display devices are shown in the exemplary embodiment in FIG. 3A, a video stream can be constructed according to the exemplary method shown in FIGS. 3A and 3B even when four display devices are used as in the system of FIG. 2. In an alternative embodiment, a video stream may be constructed in a manner shown in FIG. 3A by sequentially extracting image data for the first display device 400a, the second display device 400b, the third display device 400c, and the fourth display device 400d. When the arrangement of all pixel data of the first row is completed, pixel data of the second row is arranged from left to right to construct the video stream. When all pixel data of the second row is arranged, pixel data of each of the remaining rows of the displayed screen is sequentially arranged to construct the video stream.

FIG. 3B is a diagram illustrating an exemplary embodiment of a video stream constructed using the display devices illustrated in FIG. 3A according to the present invention.

As illustrated in FIG. 3B, the constructed video stream is composed of image data for the display devices (e.g., 1, A, 2, B, 3, C, 4, D, . . . ). The order of display devices corresponding to pixel data arranged in the video stream indicates the order of pixel data corresponding to image data outputted through a video driver. In the exemplary embodiment shown in FIGS. 3A and 3B, a unit of pixel data of the image data for the first display device 400a may be outputted first and a unit of pixel data of the image data for the second display device 400b may then outputted.

Referring back to FIGS. 2 and 5, the video stream constructed in the video stream construction unit 100 is transmitted to the display devices through the video driver 200 in operation 2000.

In operation 3000, the decoder connected to each of the display devices extracts image data required in each of the display devices from the transmitted video stream.

Image data is extracted according to the order in which the video stream is constructed. As in the illustrated embodiments in FIGS. 3A and 3B, the pixel data “1” is extracted so that it may be displayed on the screen of the first display device 400a, pixel data “A” is extracted so that it may be displayed on the screen of the second display device 400b, and the pixel data “2” is extracted so that it may be displayed on the screen of the first display device 400a. In other words, the image data is extracted so that it may be displayed on the screen of the first display device 400a and the screen of the second display device 400b alternately.

In operation 4000, each of the decoders connected to one of the display devices adjusts a clock cycle of extracted image data and outputs the image data to the corresponding display device.

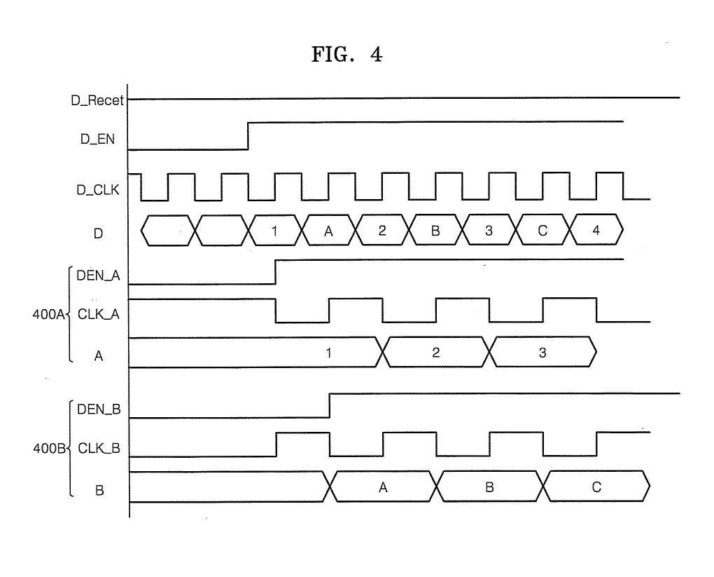

FIG. 4 is a timing diagram of an exemplary embodiment of a clock cycle of each decoder connected to one of the display devices according to the present invention.

Referring to FIG. 4, each decoder connected to one of the display devices has a clock cycle that is set to be different from the clock cycle of the video driver, which outputs image data arranged in a video stream. The clock cycle of the video driver is twice the frequency of the clock cycle of each of the decoders. In the embodiment of FIG. 4, the timing diagram for image data output from decoders in a system including two display devices (e.g., 400A and 400B), as in FIG. 3A, is illustrated. In the illustrated embodiment, the clock cycle of each decoder is adjusted to be half the frequency of the clock cycle of the video driver which outputs image data arranged in the video stream. The clock cycle of each decoder is half the frequency of the clock cycle of the video driver because alternately arranged pixel data is required to be extracted from the video stream to be displayed on the screen of each of the display devices. To form continuous image data with extracted pixel data that is alternately arranged in the video stream, such adjustment is required. The clock cycle is correspondingly adjusted according to the number of connected display devices.

In one embodiment of a system that includes two display devices, the clock cycle of each decoder is half the frequency the clock cycle of a corresponding video driver. In an alternative embodiment where a system includes three display devices, the clock cycle of each decoder is one third the frequency of a corresponding video driver. In this way, the clock cycle of each decoder is adjusted for a continuous data flow. A period of the adjusted clock cycle is a product of the period of the clock cycle of the video driver and the number of display devices. Since image data is arranged in units of pixels and outputted to a display device, a plurality of display devices can be driven with a relatively smaller storage space.

Referring back to FIG. 5, image data inputted through each decoder connected to one of the display devices is displayed by the corresponding display device in operation 5000.

As in the illustrated embodiments, a plurality of display devices are driven using a single video stream, thereby making it possible to drive the display devices with a single video driver. Since the plurality of display devices are driven using a single video driver, a system may be configured with a small number of interconnection lines. A single video stream includes pixel data corresponding to each of the display devices. Advantageously, a decoder connected to one of the display devices can drive the corresponding display device with a small line memory. In addition, since a video stream is formed so that it may be transmitted, each of the display devices may be driven using an existing interface standard.

The embodiments according to the present invention may be embodied as a program that can be implemented on computers and embedded devices, and can be implemented on digital computers executing the program using a recording medium.

A data structure used in an exemplary embodiment according to the present invention may be recorded on a computer-readable recording medium by various means.

Exemplary embodiments of the recording media include, but are not limited to, magnetic storage media, such as read-only memory (ROM), floppy disks, and hard disks, optical data storage devices, such as compact disc-read-only memory (“CD-ROM”) and digital versatile discs (“DVD”), and carrier waves such as transmission over the Internet.

While the present invention has been particularly shown and described with reference to an exemplary embodiment thereof, it will be understood by those of ordinary skill in the art that various changes in form and details may be made therein without departing from the spirit and scope of the present invention as defined by the following claims.

What is claimed is:

1. A method for driving a plurality of display devices using a single video stream, the method comprising:
constructing the single video stream, the constructing including arranging units of image data to be displayed in each of the display devices in an alternating sequence;
transmitting the constructed video stream to the display devices using a single video driver;
extracting the image data for a display device using a decoder connected to the display device according to the sequence the image data is arranged in the video stream; and
displaying the extracted image data.

2. The method of claim 1, wherein the arranged image data is used in constructing the single video stream based on a pixel unit of each of the display devices.

3. The method of claim 1, wherein extracting the image data comprises:
adjusting the clock cycle of the decoder to be different from a clock cycle of the video driver; and
extracting the image data.

4. The method of claim 3, wherein a period of the adjusted clock cycle is a product of a period of the clock cycle of the video driver and a number of the display devices.

5. A computer-readable recording medium having recorded thereon a program for implementing the method of claim 1 on a computer.

6. A system for driving a plurality of display devices using a single video stream, the system comprising:
a video stream construction unit constructing the single video stream by arranging units of image data to be displayed in each of the display devices in an alternating sequence;
a video driver transmitting the constructed video stream to the display devices; and
a plurality of decoders, each decoder being connected to one of the display devices and each decoder extracting the image data for the corresponding display device according to the sequence the image data is arranged in the video stream.

7. The system of claim 6, wherein the arranged image data is used in constructing the single video stream based on a pixel unit of each of the display devices.

8. The system of claim 6, wherein a clock cycle of each decoder is adjusted to be different from a clock cycle of the video driver

9. The system of claim 8, wherein a period of the adjusted clock cycle is a product of the period of the clock cycle of the video driver and a number of display devices.

10. A computer-readable recording medium which records thereon a program for implementing the method of claim 2 on a computer.

11. A computer-readable recording medium which records thereon a program for implementing the method of claim 3 on a computer.

12. A computer-readable recording medium which records thereon a program for implementing the method of claim 4 on a computer.
